(19) United States
(12) Patent Application Publication
(10) Pub. No.: US 2021/0241726 A1
(43) Pub. Date: Aug. 5, 2021

(54) Stringed Instrument

(71) Applicant: Archibald Ian Jeremy Brain, Bel Ombre, Mahe (SC)

(72) Inventor: Archibald Ian Jeremy Brain, Bel Ombre, Mahe (SC)

(21) Appl. No.: 16/754,993

(22) PCT Filed: Oct. 15, 2018
(86) PCT No.: PCT/GB2018/052967

§ 371 Date: Apr. 9, 2020

(30) Foreign Application Priority Data
Oct. 16, 2017 (GB) 1716973.1
Oct. 23, 2017 (GB) 1717393.1

(51) Int. Cl. G10D 3/095; G10D 3/04; G10D 1/08

(52) U.S. Cl. CPC G10D 3/095; G10D 1/08; G10D 3/04

(57) ABSTRACT

A musical instrument comprising a body and a neck for supporting a set of strings, further comprising demountable means for detaching the strings as a single piece from the instrument.

The present application relates to an instrument comprising means for detaching and/or reattaching the strings of a stringed instrument as a single piece. More particularly, the application relates to an instrument comprising interchangeable sets of strings.

Many stringed instruments have a headstock, wherein the headstock is the portion of the instrument which is at the opposite end of the instrument to the bridge. The headstock secures the strings to the neck of the instrument and positions the strings at the correct height to allow them to resonate when struck. The headstock typically comprises means for tuning the stringed instrument, e.g. in the form of tuning pegs.

In order to inspect or repair the body or neck of a stringed instrument, the strings must be individually removed. This is a time consuming process and is made further undesirable as the instrument will subsequently need to be restrung and retuned. Restringing an instrument can be a lengthy process and may involve the additional cost of new strings.

In addition, when disassembling a collapsible instrument, such as a collapsible guitar (for example, as referred to in International Patent Application Number PCT/GB2014/000139), the strings must also be removed or, alternatively, remain attached and stored within the body of the guitar which can lead to them becoming entangled. Furthermore, when disassembling the guitar, it is advantageous to remove the strings from the bridge of the instrument, for example, as described in International Patent Application Number PCT/GB2015/053286.

The present invention seeks to mitigate disadvantages such as those described above.

According to a first aspect, there is provided a musical instrument comprising a body and a neck for supporting a set of strings, further comprising demountable means for detaching the strings as a single piece from the instrument. Detaching the strings as a single piece advantageously enables the body and neck of an instrument, which would otherwise be obstructed by the strings, to be easily accessible.

According to a second aspect, there is provided a musical instrument comprising a first set of strings and a second set of strings, wherein the instrument is adapted to allow for attachment of either the first set of strings or the second set of strings. In one embodiment, the first set of strings may be a set of strings for a classical guitar and the second set of strings may be a set of strings for an acoustic guitar. Advantageously, the instrument of the present invention provides the user with the option to change the strings of the instrument as required, thus advantageously changing the nature of the instrument.

According to a third aspect, there is provided a musical instrument and a neck for supporting a set of strings, the instrument further comprising a junction box adapted to reversibly join the neck and body of the instrument and to provide structural rigidity to the neck and body of the instrument. Advantageously, the junction box provides support and ensures mechanical rigidity to the neck and body of the instrument. Advantageously, the reversible attachment of the neck and the body provides flexibility, for example, allowing the neck and body to be reversibly attached to and/or detached from one another during the assembly and/or disassembly of a collapsible instrument. Advantageously, the junction box allows the neck and body of the instrument to be quickly attached and/or detached to and/or from one another, thus improving the speed of assembly and/or disassembly of the neck and body of the instrument.

Preferably, the instrument is a collapsible instrument.

Preferably, the instrument comprises a headstock and means for detachably securing the headstock to the neck. Advantageously, the strings may be removed from the instrument without unwinding them from the headstock, therefore reducing the time taken to remove the strings.

In a preferred embodiment, in the assembled position, the neck is attached at its proximal end to the body and at its distal end to the headstock. The headstock is removably connected to the neck so that the disassembled parts can fit entirely within a space defined by the body. Preferably, the detachable securing means comprises a hinge. In addition or alternatively, a retaining means, such as a retaining hook, may be provided between the headstock and the neck, in order to prevent accidental forward displacement of the headstock during use. Preferably, the retaining means is disposed to join the back of the headstock to the back of the neck (i.e. not on the side comprising the first set of strings). Most preferably, the retaining means is resilient, for example spring loaded.

Preferably, the headstock comprises a hinge pin which attaches the headstock to the neck of the instrument. In one embodiment, the detachable securing means may be a hinge pin. Preferably, the hinge pin is provided at a substantially central position along the axis of the headstock which is substantially perpendicular to the longitudinal axis of the neck, at a position substantially adjacent to the neck. Preferably, the hinge pin engages with a corresponding attachment portion on the neck of the instrument to attach the headstock to the neck of the instrument. Preferably, the hinge pin engages with a hook provided on the neck of the instrument to attach the headstock to the neck of the instrument. In one embodiment, the hinge pin engages with the retaining hook. Preferably, a block is provided substantially adjacent to the hinge pin. Advantageously, the block prevents the strings from becoming entangled. Typically, the strings become entangled when they are loose just before tensioning, for example, because steel strings have a much shorter elongation than classical nylon strings, so that when the headstock is rotated into place, the user encounters string resistance just before the end of the rotation. Preferably, the block comprises wood.

Preferably, the tension of the strings maintains the instrument in the assembled condition.

It is preferred that the instrument comprises a guiding means for guiding the strings. During disassembly of the instrument, the relative spatial position of the strings may change considerably, which can make reassembly cumbersome and difficult. The guiding means will facilitate the reassembly process.

Preferably, the guiding means is capable of guiding the strings into position relative to each other at the nut of the neck. For example, a movable guiding means may be provided on the headstock through which the strings pass, which keeps the strings in their spatial positions relative to each other, so that when the headstock is re-attached, the strings are automatically guided into their correct positions. In addition or alternatively, the guiding means is capable of maintaining the strings in position relative to each other. The strings of the instrument may be found to be all of different lengths due to their different tension characteristics. This may cause problems of entanglement when the headstock is detached from the neck and stowed inside the body, since the strings are still attached to the headstock and the body. Preferably, the guiding means enables the strings to be trapped in position on the headstock during the disassembly process and stowage.

It is preferred that the instrument comprises first and/or second guiding means for guiding the strings.

Preferably, the first guiding means is adapted to pivot, relative to the headstock without lateral movement relative thereto to guide the strings into position relative to each other at the headstock. Preferably, the first guiding means is provided as a string locating swinging arm.

Preferably, the first guiding means comprises an aperture or a recess which may accommodate the hinge pin for attaching the headstock to the neck and/or the wooden block substantially adjacent to the hinge pin.

Preferably, the second guiding means is adapted to maintain the position of the strings relative to each other at the headstock.

It is preferred that the second guiding means comprises a fulcrum. Preferably, the second guiding means is adapted to confer tension to the strings via the fulcrum. Advantageously, the loading and/or unloading of string tension may typically be facilitated by causing all of the strings to undergo tensioning from the same mechanically advantageous point on the fulcrum provided by the headstock itself. Typically, the fulcrum is positioned above the strings and prevents the strings from lifting away from the plane of the headstock during rotation of the headstock with respect to the neck of the instrument.

Preferably, the fulcrum comprises a roller bar. It is preferred that the fulcrum is attached to the first guiding means. Preferably, the fulcrum is attached to the headstock. It is preferred that the fulcrum comprises a transverse roller bar which is typically supported by at least one bearing fixed on either side of the headstock.

Preferably, the second guiding means is adapted to serve as an axis for the first guiding means. In one embodiment, the first guiding means may rotate about the axis of the second guiding means. Preferably, the roller bar serves as the axis for the first guiding means. Typically, the roller bar is placed in position such that it traps the strings underneath it during forward and/or backward rotation of the headstock, thus advantageously preventing the strings from lifting away from the plane of the headstock front surface during rotation of the headstock, which might otherwise loosen them from their attachment to the vertically disposed winding gear pegs (e.g. tuning pegs) typically used in acoustic guitar type winding gear apparatus.

Preferably, the fulcrum facilitates the loading and/or unloading of string tension by causing all the strings to undergo tensioning from the same mechanically advantageous point on the fulcrum provided by the headstock itself.

In one embodiment, the second guiding means is attached to the headstock by means of a retaining pin. Preferably, the retaining pin may be inserted through substantially the centre of the second guiding means. Preferably, the retaining pin holds the second guiding means in position by interaction with at least one bearing provided on the headstock. Preferably, the at least one bearing comprises an aperture through which the retaining pin may pass. Preferably, the retaining pin passes through the at least one bearing and the second guiding means to hold the second guiding means in the assembled configuration. Preferably, the retaining pin serves as a string guide pivot rod and thus is an important integral part of the string guiding means. Preferably, the retaining pin serves as a string guide pivot rod and is thus an important integral part of the second guiding means. Typically, the retaining pin is not intended to be removed unless it is necessary to change the string guide body, i.e. the second guiding means. In one embodiment, removal of the retaining pin from the second guiding means and the at least one bearing may remove the second guiding means from the headstock of the instrument such as for maintenance.

In one embodiment, the second guiding means may be attached to a central rib of the headstock, wherein the central rib of the headstock is the part of the headstock that separates the slots comprising the string winding drums of the tuning pegs. Preferably, the second guiding means is provided as an axis rod, typically a fulcrum, which is typically rotatably attached to the central rib of the headstock. Preferably, the second guiding means is attached to the headstock by at least one retaining plate. Preferably, the second guiding means is attached to the headstock by two retaining plates. Advantageously, the attachment of the second guiding means to the central rib of the headstock assists the user in accessing the string winding drums of the tuning pegs, thus assisting in the process of changing the strings of the instrument. Advantageously, the attachment of the second guiding means to a central rib of the headstock means that it is not necessary for the strings of the instrument to pass under the second guiding means. Typically, a levering lock may be used to assist in tensioning the strings of the instrument. Preferably, the instrument that may be used in this embodiment is a classical guitar, preferably a classical Spanish guitar.

In another embodiment, the second guiding means provides an axis, preferably an axis rod, under which the strings of the instrument may pass. Preferably, the second guiding means is provided as a fulcrum. Advantageously, in this embodiment, the second guiding means prevents the strings of the instrument from becoming detached from the string winding pins of the tuning pegs. Preferably, the second guiding means is attached to the headstock by at least one retaining plate. Preferably, two retaining plates are provided which are substantially close to one another. In one embodiment, the axis rod may extend beyond the plates on either side, capturing the strings as in previous embodiments during the string tensioning manoeuvre. Preferably, the second guiding means is rotatably attached to the first guiding means. It is preferred that the second guiding means is positioned above the strings of the instrument when the instrument is in the assembled configuration. Preferably, a central portion of the second guiding means is attached to the first guiding means and/or to the headstock, wherein the second guiding means comprises free outer ends (i.e. ends which are not attached to another component). Advantageously, the free outer ends allow the user to feed the strings under the second guiding means, assisting the user when changing the strings of the instrument. Preferably, the instrument that may be used in this embodiment is a steel string acoustic guitar.

Preferably, the user may replace a headstock comprising a set of classical strings having a second guiding means attached to a central rib on the headstock with a headstock comprising a set of steel strings comprising a second guiding means having free outer ends.

Preferably, the instrument further comprises a slidable extension part adapted to assist in attaching and/or detaching the headstock from the neck of the instrument. Preferably, the slidable extension part is provided at the distal end of the headstock (i.e. the end of the headstock that is furthest from the neck). Preferably, the slidable extension part is movable from a first position where it is substantially adjacent to the distal end of the headstock to a second position where it extends from the distal end of the headstock. Advantageously, when the slidable extension part is in the second position, the length of the headstock is effectively extended such that the effort required to detach or attach the headstock from or to the neck is reduced. Preferably, the slidable extension part provides a lever to assist in rapid release of the headstock from the instrument. The slidable (also known as a retractable) extension part advantageously assists in overcoming the high resistance offered by steel strings of an instrument

Preferably, the neck is removably connected to the body. Preferably, the instrument comprises means for detachably securing the neck to the body. The securing means may include means to secure the neck to the body in the assembled position. It is preferred that the instrument further comprises means for adjusting the neck relative to the body of the instrument.

In one embodiment, the mechanism of attaching the neck to the body may comprise a latch member mounted on the body of the instrument which engages with a locking member mounted on the neck of the instrument. Advantageously, the mechanism of this embodiment does not require the use of any loose fixation parts, such as nuts and bolts, and does not require the use of tools. Preferably, the latch member may be substantially L-shaped and may comprise a biasing means, for example, in the form of a locking spring. The provision of a biasing means advantageously assists in the engagement of the latch member with the locking member. Preferably, an operating handle may be provided to enable a user to move the latch member from a latched position where it engages with a locking member provided on the neck of the instrument, to a disengaged position against the bias of the locking spring. In one embodiment, the operating handle may be attached to the latch member.

In another embodiment, the neck may be attached to the body of the instrument via a fixation bolt.

Preferably, the junction box acts as an anchor point to connect the neck and body of the instrument.

Preferably, the junction box houses a reversible attachment mechanism for reversibly attaching and/or detaching the neck to and/or from the body of the instrument. Preferably, the junction box comprises means for detachably securing the neck to the body of the instrument.

Preferably, the reversible attachment mechanism comprises locking and/or unlocking means. In one embodiment, the reversible attachment mechanism comprises a latch member, wherein the latch member is preferably mounted on the junction box. In one embodiment, the latch member may be mounted on a heel of the junction box. Preferably, the latch member comprises a hook element. Preferably, the latch member may engage with a locking member provided on the neck of the instrument. In one embodiment, the latch member may engage with a locking aperture provided on the neck of the instrument. In another embodiment, the locking member or locking aperture may be provided on the body of the instrument. In one embodiment, the latch member may be substantially L-shaped.

In one embodiment, the latch member may be rotatable. In one embodiment, the instrument may further comprise an operating handle that may be attached to the heel of the junction box. Preferably, the operating handle may be attached to the latch member. Preferably, rotation of the operating handle may drive movement of the latch member, to enable a user to move the latch member from a latched position where it engages with a locking member or aperture to a disengaged position. Rotation of the operating handle in the opposite direction may drive movement of the latch member from a disengaged position to a position where it engages with a locking member or aperture. Preferably, rotation of the operating handle drives movement of the latch member to enable a user to move the latch member from a locked and/or unlocked position to an unlocked and/or locked position.

In another embodiment, the latch member may comprise biasing means, for example, in the form of a locking spring. The provision of a biasing means advantageously assists in the engagement of the latch member with the locking member or locking aperture. Preferably, the operating handle may be provided to enable a user to move the latch member from a latched position where it engages with a locking member or aperture provided on the neck of the instrument, to a disengaged position against the bias of the locking spring.

Typically, the latch member extends to a position just below, in use, the position of the neck of the instrument when the instrument is in the assembled position.

Advantageously, the reversible attachment mechanism does not require the use of any loose fixation parts such as nuts and bolts.

In another embodiment, the neck may be attached to the junction box of the instrument by means of a fixation bolt. Preferably, the fixation bolt is provided on the junction box. Preferably, the fixation bolt secures the junction box to the neck of the instrument.

Preferably, the junction box is housed inside the body of the instrument. In one embodiment, the junction box may be held in place within the body of the instrument by means of a fixation bolt, glue or other attachment means.

Preferably, the junction box comprises wood or a plastics material such as nylon and/or polyoxymethylene (known as Delrin). In one embodiment, the junction box may comprise nylon 12. Advantageously, the provision of a junction box comprising a plastics material such as nylon and/or Delrin increases the strength and/or rigidity of the junction box. Advantageously, the provision of a junction box comprising wood provides flexibility and allows for adjustments to the shape of the junction box, if required. In addition, the provision of a junction box comprising wood facilitates attachment of other components (such as a bolt) to the junction box.

In one embodiment, the junction box may be formed by 3D printing. Preferably, the junction box may be formed by 3D printing using a plastics material such as nylon and/or polyoxymethylene (known as Delrin). Advantageously, forming the junction box by 3D printing facilitates manufacture of the junction box. Advantageously, forming the junction box by 3D printing reduces the number of components required to form the junction box. In other embodiments, the junction box may be formed by other moulding methods, for example, injection moulding.

In one embodiment, the junction box may comprise grooves to facilitate attachment of the neck to the junction box.

In a preferred embodiment, in the assembled position, the neck is attached at its proximal end to the body and at its distal end to a headstock of the instrument.

Preferably, at least one wheel is provided to permit the neck of the instrument to be adjusted. Preferably, at least two wheels are provided to permit the neck of the instrument to be adjusted. Preferably, the at least one wheel is rotatable. Preferably, the at least one wheel permits the neck of the instrument to rotate slightly to the left or right side about its longitudinal axis. Preferably, rotation of the at least one wheel adjusts the position of the neck relative to the strings. Preferably, the at least one wheel comprises a rim which is thicker on one side than the other, so that each side of the neck can be raised or lowered with respect to the strings depending on the thickness of the rim of the wheel where it bears against the grooved bearing surface of the junction box. Preferably, the at least one wheel is marked on the outer-facing surface such that the user can identify which is the maximum area of thickness and which is the minimum area of thickness. Typically, the maximum area of thickness is around 5 mm. Typically, the minimum area of thickness is around 2 mm. Typically, adjustment of the at least one wheel can only be made when the neck is not locked in place. In another embodiment, if the wheels are made with sufficiently wide rims they can be accessed by a user when the neck is in situ to aid its adjustment. Advantageously, the presence of at least one wheel allows the user to adjust the height of the strings from the neck differentially on the left and right sides. Typically, the lighter strings on one side have a smaller vibrating amplitude than the heavier strings on the other side. Advantageously, the presence of at least one wheel provides a mechanism to ensure the optimal relative gap between the strings and the neck on the right and left hand side strings respectively.

Preferably, the instrument further comprises a bridge for receiving the strings and means for securing the strings to the bridge. Since the tension on the strings is reduced to substantially zero every time the instrument is disassembled, it happens that sometimes the attachment of the strings to the bridge works loose, necessitating their re-attachment. To prevent this from occurring, the strings may be secured to the bridge. Preferably, the instrument comprises means for preventing the strings becoming detached from the bridge when the headstock is removed during disassembly.

Preferably, the bridge comprises a detachable portion and a non-detachable portion. It is preferred that the non-detachable portion is adapted to secure to the detachable portion. Advantageously, the bridge is separated into two portions and the portion that is non-detachable can be used to quickly and efficiently secure the detachable portion. This allows the user to detach and replace the strings to the body of the instrument with minimum effort. Preferably, the detachable and non-detachable portions form the bridge of the instrument. Advantageously, providing a detachable bridge allows the strings to be detached from the instrument without them becoming disordered and entangled. On many stringed instruments, the strings are secured to the instrument by passing them through an aperture in the bridge at one end of the instrument. For example, guitars have a bridge that secures the strings to the body of the guitar at one end and to the head of the guitar at the other end. Having a detachable bridge is advantageous as it allows the strings to be detached in order to inspect or replace features of the body or guitar or neck of the guitar, for example, the frets of a guitar can become worn and in need of replacement. Alternatively, a detachable bridge may be useful as part of the disassembly of a collapsible guitar. In one embodiment, the detachable portion of the bridge may be used in conjunction with the detachable headstock, to remove the strings as a single piece. Advantageously, the combination of a detachable bridge and a detachable headstock may form a means for removing the strings from a stringed instrument. Advantageously, the combination of a detachable bridge and a detachable headstock provide a quick release mechanism for removing the strings from the instrument.

Preferably, the detachable portion further comprises means for coupling and/or uncoupling the strings of the instrument. Typically, the means for coupling or uncoupling the strings comprises at least one aperture for each of the strings in the detachable portion. This allows the strings to be secured to the detachable portion and to be detached from the body of the instrument as one piece.

Preferably, the non-detachable portion comprises a string retaining channel for each of the strings which correspond to the position of the strings coupled to the detachable portion such that when the detachable portion is secured by the non-detachable portion, the strings coupled to the detachable portion each sit within a corresponding string retaining channel. The string retaining channels of the non-detachable portion allow the strings coupled to the detachable portion to be held securely in the correct position and allow the strings to be repeatedly struck to create sound without altering the position of the strings along the bridge.

Preferably, the non-detachable portion comprises a retaining means to prevent inadvertent detachment of the detachable portion, the retaining means adapted to retain the detachable portion against the tension of the strings. This advantageously allows the detachable portion to be held securely to the body of the guitar without the need for any additional components. The retaining means allows the detachable portion to couple to the non-detachable portion and affix the detachable portion firmly without further input or effort from a user. The tension generated by the string forces the detachable portion into contact with the non-detachable portion.

Preferably, the retaining means comprises means to prevent movement of the detachable portion in a direction substantially perpendicular to the direction of the body. Advantageously, the retaining means prevents the force generated by the taut strings on the instrument from pulling the string away from the body of the stringed instrument. Without the retaining means the strings would be forced away from the body of the stringed instrument and the detachable portion forced perpendicular to the body of the stringed instrument.

It is preferred that the retaining means comprises a lip, wherein the lip protrudes in a plane substantially parallel to the body of the instrument in a direction away from the neck of the stringed instrument. Preferably, the lip protrudes from the non-detachable portion on the end of the detachable portion facing in a direction away from the neck of the stringed instrument. The projection from the non-detachable portion that forms the lip holds the detachable portion in place and provides a stop that secures the detachable portion due to the force of the strings pulling the detachable portion towards the neck and also perpendicular to the body of the instrument.

Preferably, the lip comprises the string retaining channels through which each string can pass. The string retaining channels allow the strings of the stringed instrument to be guided into position so that they can be secured to the detachable portion and not move when the instrument is played.

It is preferred that the detachable and/or non-detachable portion has a tongue. Preferably, the detachable and/or non-detachable portion comprises a groove, wherein the tongue reversibly couples to the groove such that the tongue is secured by the groove. A tongue and groove arrangement is advantageous as it provides a stable, reversibly releasable system that does not require additional materials to be used in securing the detachable portion to the non-detachable portion.

Preferably, the strings may be removed from the instrument via the headstock and/or via the bridge. Preferably, the instrument comprises means for rapid release of the strings from the instrument. Preferably, the rapid release means may be provided by the detachable headstock, the string guiding means, the detachable portion of the bridge and/or the slidable extension part.

Preferably, the instrument is a guitar. More preferably, the instrument is a collapsible guitar. Preferably, the instrument may be an acoustic or classical Spanish guitar.

According to a fourth aspect, there is provided a method of reversibly attaching a neck and body of an instrument comprising a junction box according to the third aspect.

According to a fifth aspect, there is provided a method of forming an instrument comprising a junction box according to the third aspect.

Preferably, the method of forming the junction box comprises the step of 3D printing. In another embodiment, the method of forming the junction box comprises the step of injection moulding.

Preferably, the instrument comprises a three-point fixation method, comprising the use of the junction box, the means for detachably securing the headstock to the neck and the bridge.

Preferably, the present invention allows for an instrument to be provided with interchangeable sets of removable rapid-release and rapid refit headstocks fitted with strings and string-guides in which said headstocks and said strings may be, for example, of the acoustic or classical guitar type, and in which each set of strings may be pre-attached to a detachable portion of a bridge, the detachable portion of the bridge being designed to reversibly slot into the rear aspect of the non-detachable portion of the bridge, the non-detachable portion of the bridge being fixed by conventional means to the front panel of an instrument body (e.g. an instrument sound box).

Preferably, the present invention provides a mechanism for detaching a headstock from, or reattaching a headstock to, a collapsible stringed instrument without unwinding the strings from the headstock and/or separating them from their attachments at the opposite end, the mechanism simultaneously also either relaxing and/or appropriately tensioning the strings. Typically, relaxing the strings permits the immediate removal of the headstock and strings, for example, for stowing the headstock and/or neck within the body of the instrument. Typically, tensioning the strings holds and/or locks the headstock and the distal string attachment in place on the instrument.

Preferably, the invention permits a player to rapidly exchange a complete assembly of a headstock, ready mounted strings and the detachable portion of a bridge, which can all be removed as one unit at the same time, such that the combined tension of the strings is caused to return to zero by the forward rotation of the headstock on its hinged attachment to the guitar neck. Preferably, the assembly may be replaced with a second assembly unit designed to fit on the same instrument. Advantageously, this may assist a player in rapidly exchanging a set of classical strings from a low-tension variety to a harder version variety, allowing different performance characteristics for a different piece of music.

Preferably, the present invention allows a player to exchange a classical guitar set of guitar strings for an acoustic set of guitar strings, or vice versa, thus changing the nature of the instrument. Preferably, the rapid release mechanism for removing the headstock and the detachable portion of the bridge, together with the strings to which they remain attached, is simply reversed after slotting into place the new headstock and the new detachable portion of the bridge. Preferably, the action of rotating the headstock backwards on its reversible hinged attachment to the outer end of the neck simultaneously tensions the strings and clamps the assembly in place, making for an extremely short overall exchange time.

Preferably, the neck of the instrument may be separated from the headstock and also from the body of the guitar using a mechanism, in the latter case, which permits fine adjustment of the angle of the neck with respect to the plane of the front of the body of the instrument. Advantageously, such adjustment may be desirable when changing between different string types, for example, acoustic guitar players find it easier to play using a smaller distance between the neck and strings than is usually provided in classical guitars. Preferably, the adjustments to the angle of the neck are made after tensioning the strings, preferably by loosening the neck to body fixation bolt to a greater extent (e.g. in the case of a classical guitar arrangement) or a lesser extent (e.g. in the case of an acoustic guitar arrangement).

Advantageously, the present invention permits a player to avoid the sometimes lengthy process of tuning the strings. For example, if a string breaks during a performance, it is usually necessary for a player to use a spare instrument rather than keeping the audience waiting while a new string is fitted and tuned. Advantageously, the present invention allows an entire set of strings to be exchanged with another set of strings which have previously been tuned, without the requirement for the player to use a spare instrument which he may not be familiar with and which may not have the same characteristics. Advantageously, when replacing the strings in accordance with the present invention, it has been found that only small changes in tuning are required after re-tensioning, in the case of classical guitar strings, while in the case of acoustic guitar strings usually little or no adjustments to the tuning pegs are required, unless the neck-to-guitar body angle has been changed.

The invention will be further described by way of example, with reference to the following drawings and figures, in which:

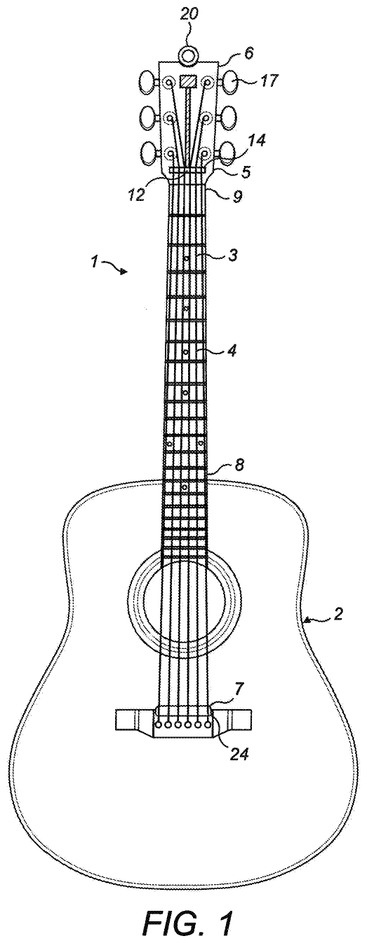

FIG. 1 is a front plan view of a musical instrument according to an embodiment of the invention;

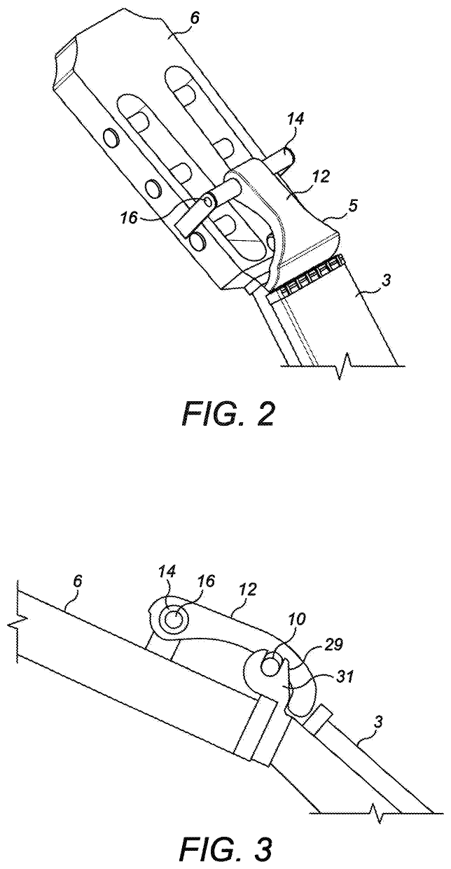

FIG. 2 is a perspective view of a headstock according to an embodiment of the invention;

FIG. 3 is a side plan view of a headstock according to an embodiment of the invention;

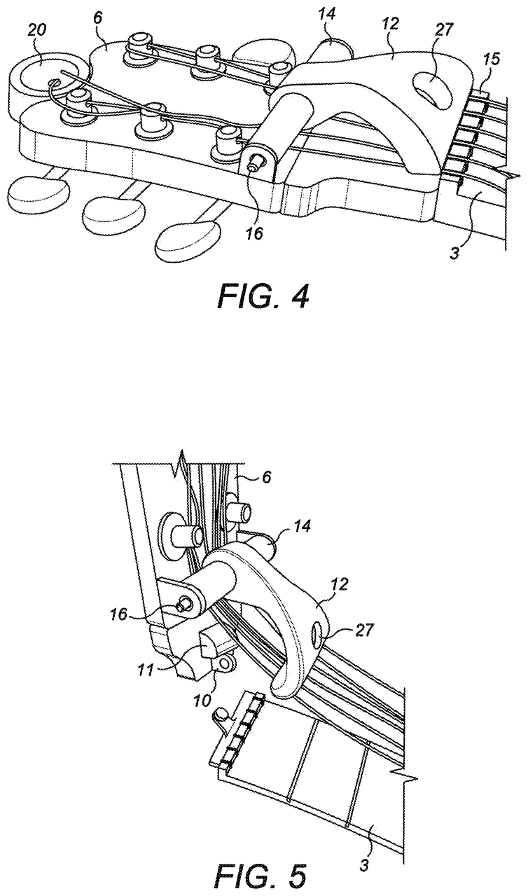

FIG. 4 is a further perspective view of a headstock according to an embodiment of the invention;

FIG. 5 is a side perspective view of a headstock in a detached configuration according to an embodiment of the invention;

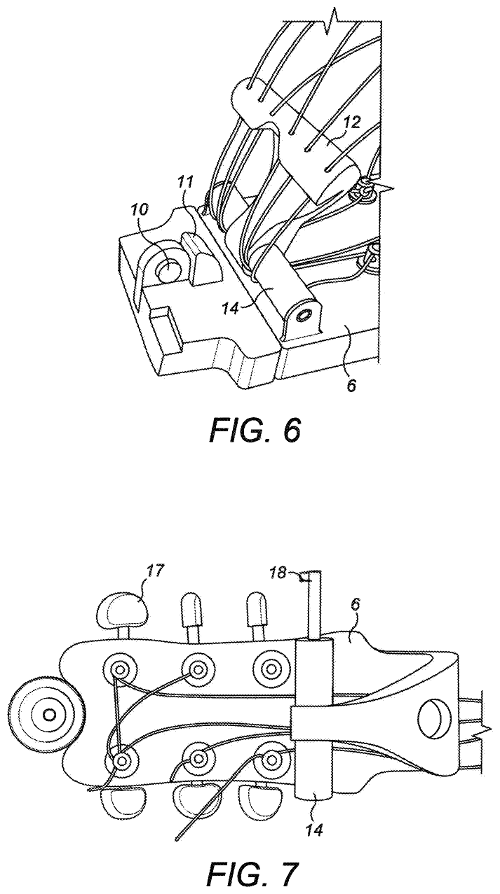

FIG. 6 is a perspective view of part of a headstock according to an embodiment of the invention;

FIG. 7 is a front view of a headstock according to an embodiment of the invention;

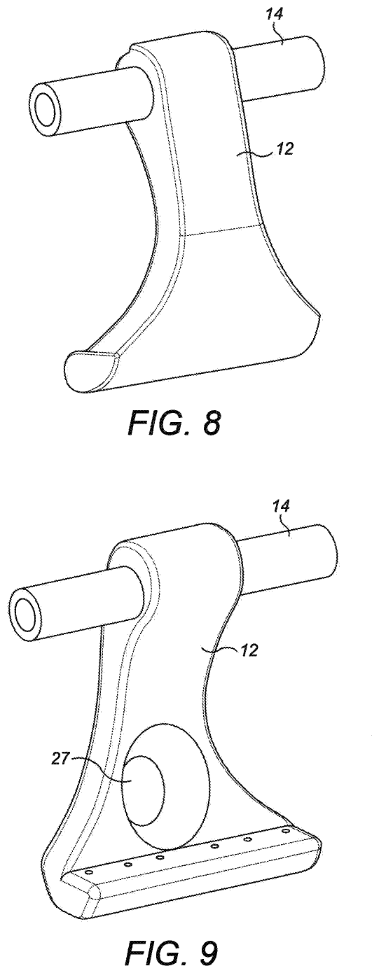

FIG. 8 is a front perspective view of string guiding means according to an embodiment of the invention;

FIG. 9 is a rear perspective view of string guiding means according to an embodiment of the invention;

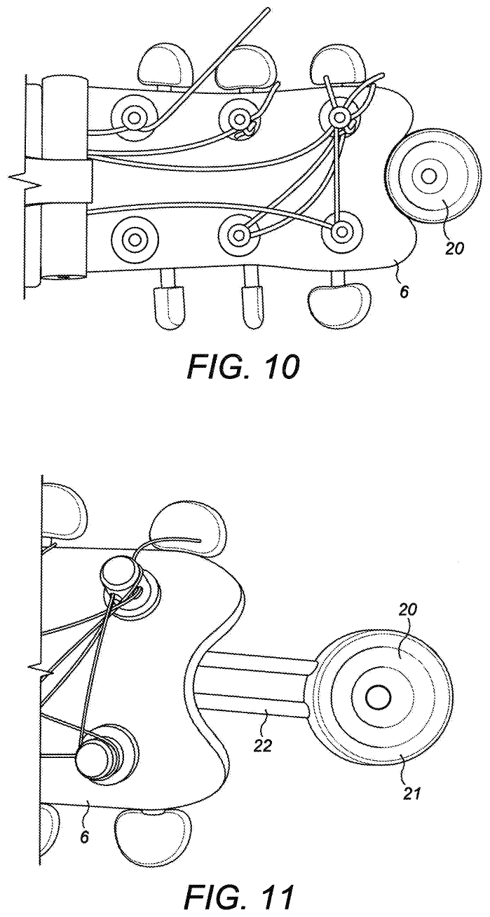

FIG. 10 is a front view of a headstock according to an embodiment of the invention;

FIG. 11 is a front view of part of a headstock according to an embodiment of the invention;

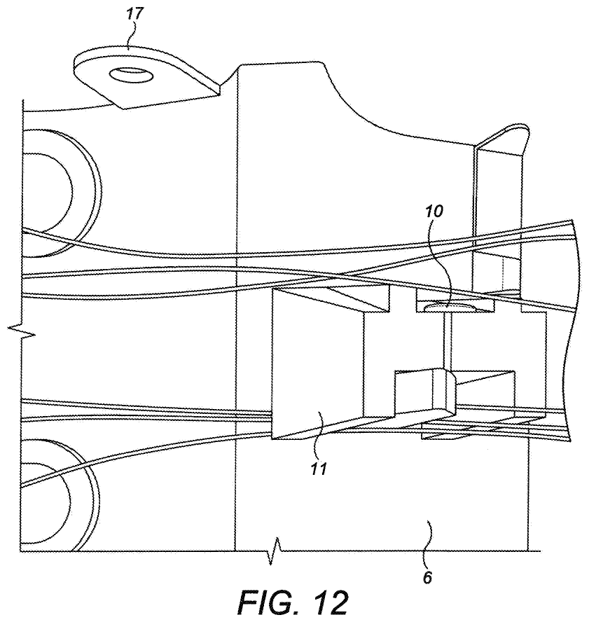

FIG. 12 is a front view of part of a headstock according to an embodiment of the invention;

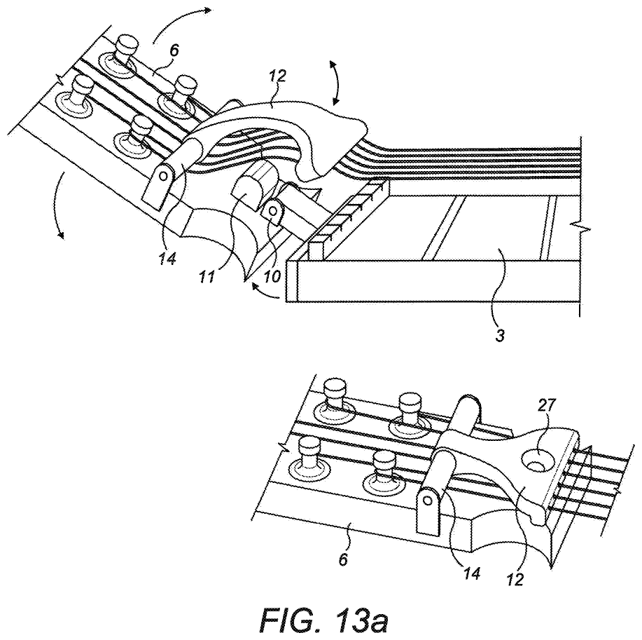

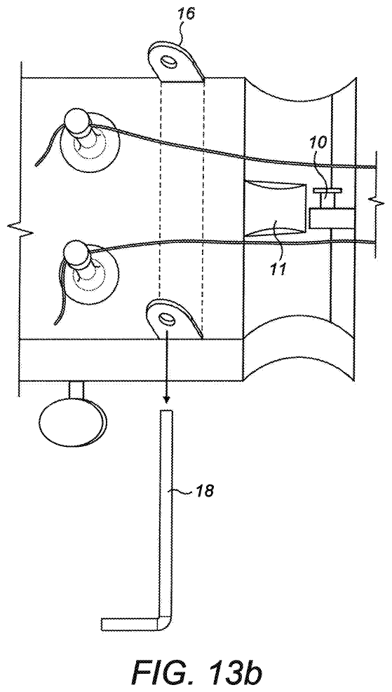

FIG. 13a is a plan view of part of a neck and part of a headstock according to an embodiment of the invention;

FIG. 13b is a plan view of part of a headstock according to an embodiment of the invention;

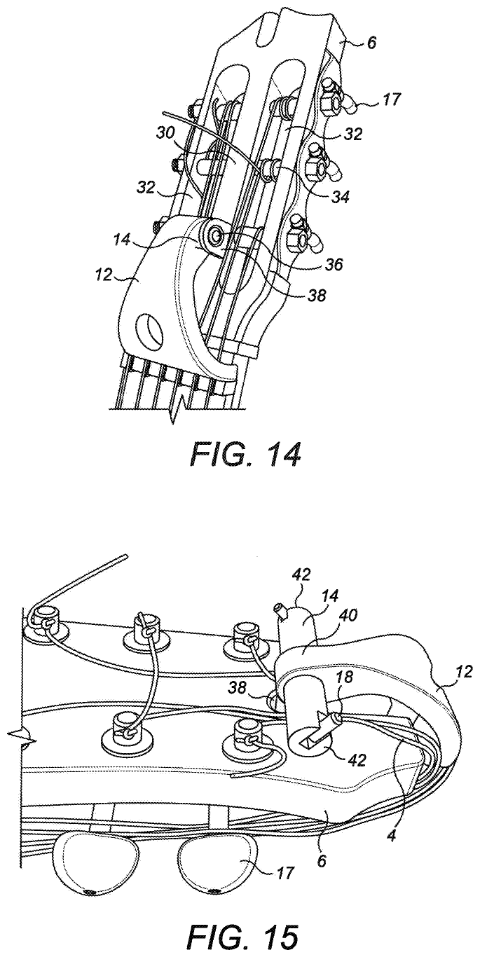

FIG. 14 is a front perspective view of a headstock according to an embodiment of the invention;

FIG. 15 is a front perspective view of part of a headstock according to another embodiment of the invention;

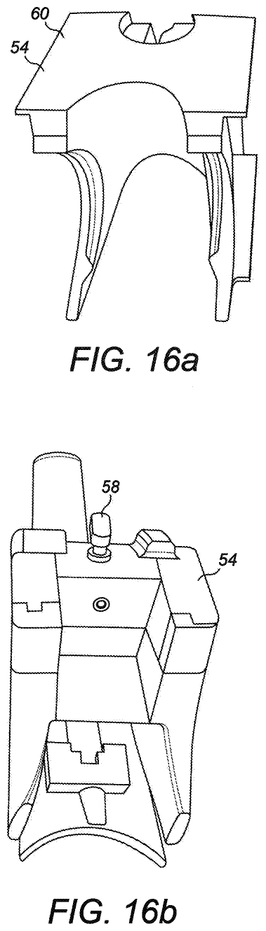

FIG. 16a is a rear perspective (underside) view of a junction box according to an embodiment of the invention;

FIG. 16b is a front perspective (inner end) view of a junction box according to an embodiment of the invention;

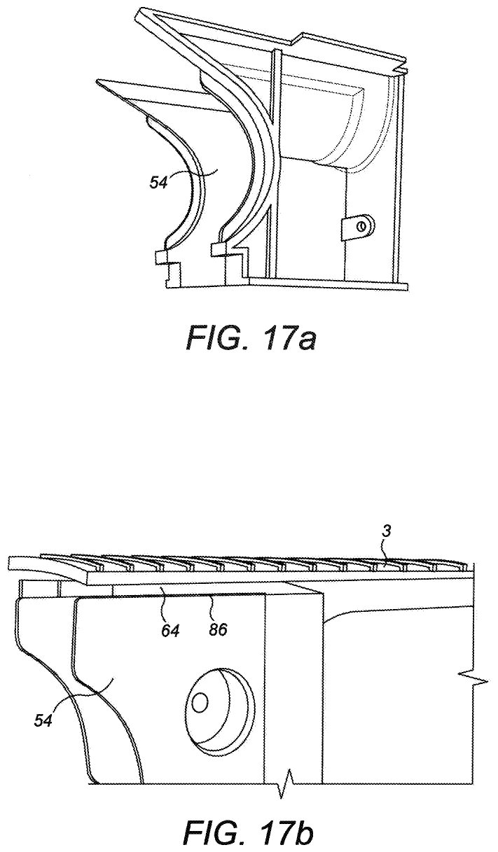

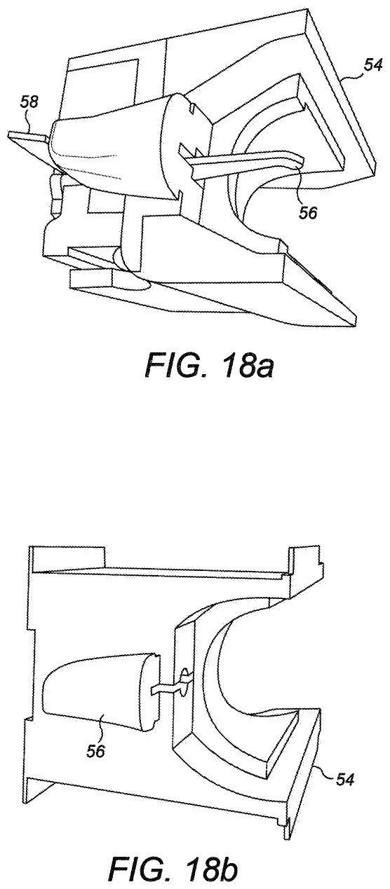

FIG. 17a is a perspective side view of a junction box according to an embodiment of the invention;

FIG. 17b is a perspective side view of a junction box in combination with a neck of an instrument according to an embodiment of the invention;

FIG. 18a is a perspective view from below (rear view) of a junction box according to an embodiment of the invention;

FIG. 18b is a perspective view from below (rear view) of a junction box according to an embodiment of the invention;

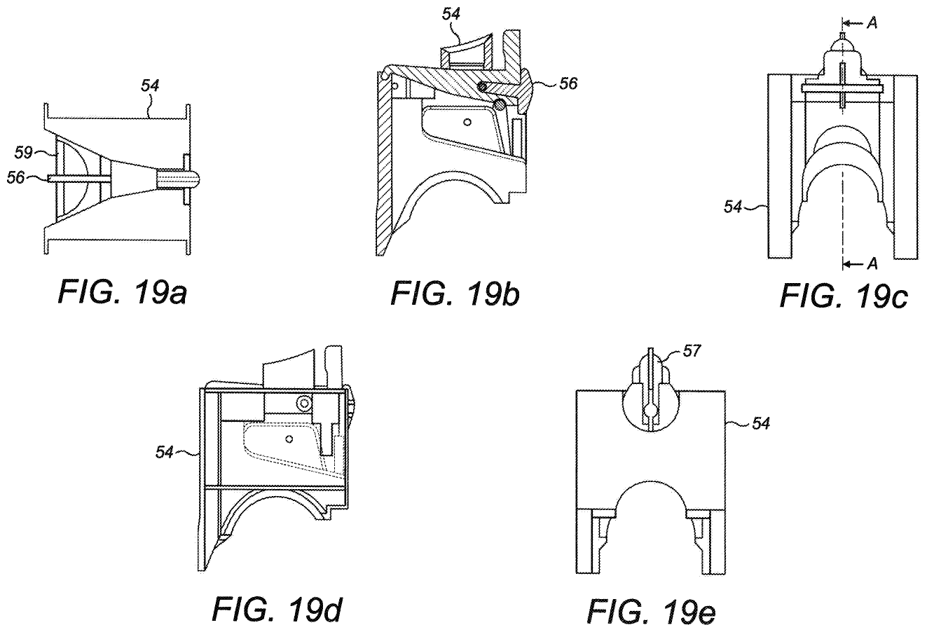

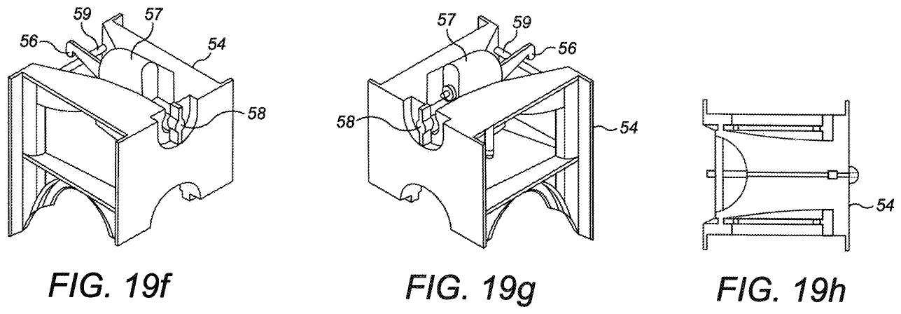

FIG. 19a is a plan view from above of a junction box according to an embodiment of the invention;

FIG. 19b is a side plan view of a junction box according to an embodiment of the invention;

FIG. 19c is a front plan view of a junction box according to an embodiment of the invention;

FIG. 19d is a side plan view of a junction box according to an embodiment of the invention;

FIG. 19e is a plan view from behind of a junction box according to an embodiment of the invention;

FIG. 19f is a front perspective plan view of a junction box according to an embodiment of the invention;

FIG. 19g is a front perspective plan view of a junction box according to an embodiment of the invention;

FIG. 19h is a plan view from below of a junction box according to an embodiment of the invention; and

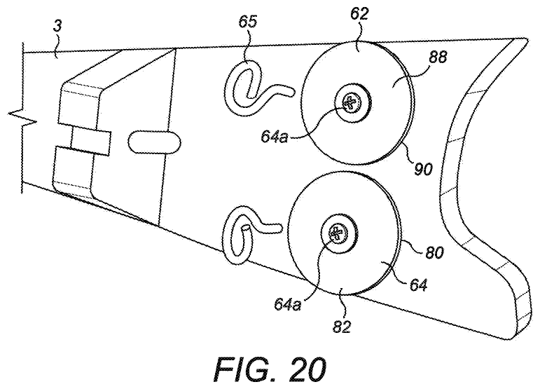

FIG. 20 is a perspective view from above of the means for adjusting the position of the neck of the instrument;

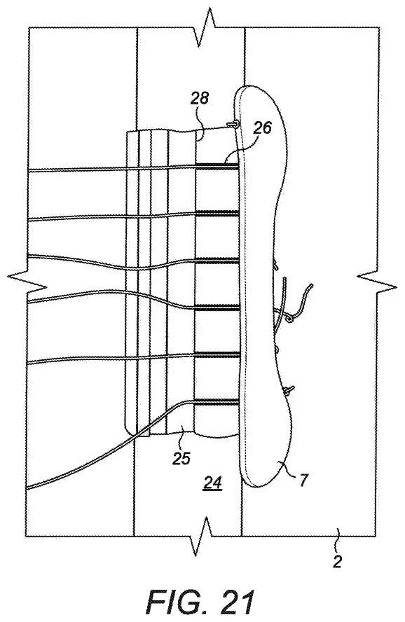

FIG. 21 is a front plan view of a bridge according to an embodiment of the invention;

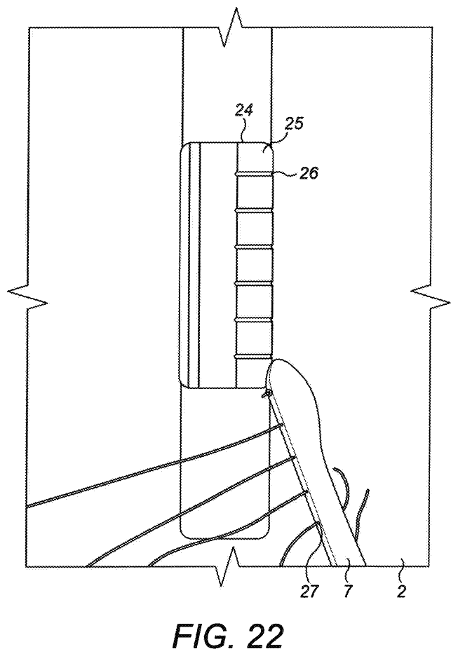

FIG. 22 is a front plan view of a bridge according to an embodiment of the invention;

According to FIGS. 1 to 7, there is provided a musical instrument 1 comprising a body 2 and a neck 3 for supporting a set of strings 4, further comprising demountable means 5, 7 for detaching the strings as a single piece from the instrument. Detaching the strings as a single piece advantageously enables the body and neck of an instrument, which would otherwise be obstructed by the strings, to be easily accessible.

According to FIGS. 1 to 7, there is also provided a musical instrument 1 comprising a first set of strings and a second set of strings, wherein the instrument 1 is adapted to allow for attachment of either the first set of strings or the second set of strings. In one embodiment, the first set of strings is a set of strings of a classical guitar and the second set of strings is a set of strings of an acoustic guitar. Advantageously, the instrument of the present invention provides the user with the option to change the strings of the instrument as required, advantageously changing the nature of the instrument.

According to FIGS. 16 to 19, there is provided a musical instrument 1 and a neck for supporting a set of strings, the instrument further comprising a junction box 54 adapted to reversibly join the neck 3 and body 4 of the instrument and to provide structural rigidity to the neck and body of the instrument. Advantageously, the junction box provides support and ensures mechanical rigidity to the neck and body of the instrument.

It is preferred that the instrument is a collapsible instrument.

The instrument comprises a headstock 6 and means for detachably securing the headstock to the neck. Advantageously, the strings 4 may be removed from the instrument without unwinding them from the headstock, therefore reducing the time taken to remove the strings.

In the assembled position, the neck 3 is attached at its proximal end 8 to the body and at its distal end 9 to the headstock. The headstock is removably connected to the neck so that the disassembled parts can fit entirely within a space defined by the body. The detachable securing means comprises a hinge 10. In addition or alternatively, a retaining means, such as a retaining hook, may be provided between the headstock and the neck, in order to prevent accidental forward displacement of the headstock during use. The retaining means is disposed to join the back of the headstock to the back of the neck (i.e. not on the side comprising the first set of strings). In one embodiment, the retaining means is resilient, for example spring loaded.

The headstock comprises a hinge pin 10 which attaches the headstock 6 to the neck 3 of the instrument. As shown in FIG. 3, the hinge pin 10 provided on the headstock 6 engages with a hook 31 provided on the neck of the instrument, to attach the headstock to the neck of the instrument. A wooden block 11 is provided substantially adjacent to the hinge pin. Advantageously, the block prevents the strings from becoming entangled. The arrangement of the hinge pin 10 and block 11 provided on the headstock is illustrated in FIG. 12. The hinge pin 10 is provided at a substantially central position along the axis of the headstock that is substantially perpendicular to the longitudinal axis of the neck, preferably at a position that is substantially adjacent to the neck.

Advantageously, the tension of the strings maintains the instrument in the assembled condition.

The instrument comprises a guiding means 12, 14 for guiding the strings. During disassembly of the instrument, the relative spatial position of the strings may change considerably, which can make reassembly cumbersome and difficult. The guiding means will facilitate the reassembly process.

The guiding means is capable of guiding the strings into position relative to each other at the nut 15 of the neck 3. For example, a movable guiding means may be provided on the headstock 6 through which the strings pass, which keeps the strings in their spatial positions relative to each other, so that when the headstock is re-attached, the strings are automatically guided into their correct positions. In addition or alternatively, the guiding means is capable of maintaining the strings in position relative to each other. The strings of the instrument may be found to be all of different lengths due to their different tension characteristics. This may cause problems of entanglement when the headstock is detached from the neck and stowed inside the body, since the strings are still attached to the headstock and the body. This guiding means enables the strings to be trapped in position on the headstock during the disassembly process and stowage.

The instrument comprises first and second guiding means 12, 14 for guiding the strings.

The first guiding means 12 is adapted to pivot, relative to the headstock 6 without lateral movement relative thereto to guide the strings into position relative to each other at the headstock. As shown, for example, in FIG. 5, the first guiding means 12 is provided as a string locating swinging arm. Preferably, the first guiding means comprises an aperture 27 or recess 29 to accommodate the hinge pin 10 and/or wooden block 11.

Advantageously, the second guiding means 14 is adapted to maintain the position of the strings relative to each other at the headstock.

As shown, for example, in FIGS. 5 and 6, the second guiding means 14 comprises a fulcrum. Preferably, the second guiding means is adapted to confer tension to the strings via the fulcrum. Advantageously, the loading and/or unloading of string tension may be facilitated by causing all of the strings to undergo tensioning from the same mechanically advantageous point on the fulcrum provided by the headstock itself.

Typically, the fulcrum 14 is positioned above the strings and prevents the strings from lifting away from the plane of the headstock during rotation of the headstock with respect to the neck of the instrument.

As shown, for example, in FIG. 2, the fulcrum comprises a roller bar. The fulcrum 14 is attached to the first guiding means 12. The fulcrum 14 is attached to the headstock 6 and comprises a transverse roller bar which is typically supported by bearings 16 fixed on either side of the headstock 6.

The second guiding means 12 is adapted to serve as an axis for the first guiding means 14. In one embodiment, the first guiding means 12 may rotate about the axis of the second guiding means 14. In this embodiment, the roller bar 14 serves as the axis for the first guiding means 12. Typically, the roller bar 14 is placed in position such that it traps the strings underneath it during forward and/or backward rotation of the headstock, thus advantageously preventing the strings from lifting away from the plane of the headstock front surface during rotation of the headstock, which might otherwise loosen them from their attachment to the vertically disposed winding gear pegs 17 (e.g. tuning pegs) typically used in acoustic guitar type winding gear apparatus.

Advantageously, the fulcrum 14 facilitates the loading and/or unloading of string tension by causing all the strings to undergo tensioning from the same mechanically advantageous point on the fulcrum provided by the headstock itself.

The first and second guiding means 12, 14 are attached to the headstock 6 by means of a retaining pin 18 (as shown in FIG. 7). The retaining pin 18 may be inserted through the centre of the roller bar 14 and holds the roller bar 14 in position by interaction with at least one bearing 16 provided on the headstock. The at least one bearing 16 comprises an aperture 17 through which the retaining pin 18 may pass. The retaining pin 18 passes through the at least one bearing 16 and the centre of the roller bar 14 to hold the second guiding means in the assembled configuration. Removal of the retaining pin 18 from the roller bar 14 and at least one bearing 16 removes the second guiding means 14 from the headstock 6 of the instrument such as for maintenance. The retaining pin 18 serves as a string guide pivot rod and thus is an important integral part of the guiding means. Typically, the retaining pin is not intended to be removed unless it is necessary to change the guiding means 12, 14.

In the embodiment shown in FIG. 14, the second guiding means 14 is attached to a central rib 30 of the headstock 6, wherein the central rib of the headstock is the part of the headstock that separates the two slots 32 comprising the string winding drums 34 of the tuning pegs 17. The second guiding means 14 is provided as an axis rod, which is rotatably attached to the central rib 30 of the headstock 6. In this embodiment, a pin 36 passes through the centre of the second guiding means, wherein the pin is attached to retaining plates 38 which are attached to either side of the central rib 30. Advantageously, the attachment of the second guiding means 14 to the central rib 30 of the headstock 6 assists the user in accessing the string winding drums 34 of the tuning pegs 17, thus assisting in the process of changing the strings of the instrument. Typically, a levering lock may be used to assist in tensioning the strings of the instrument. The instrument that may be used in this embodiment is a classical guitar.

In the embodiment shown in FIG. 15, the second guiding means 14 provides an axis rod, under which all of the strings 4 of the instrument pass. Advantageously, in this embodiment the second string guiding means prevents the strings of the instrument from becoming detached from the string guiding drums 34 of the tuning pegs 17. In this embodiment, the second guiding means is attached to the headstock by retaining plates 38 which are positioned substantially close to one another. In one embodiment, the axis rod may extend beyond the plates on either side, capturing the strings as in previous embodiments during the string tensioning manoeuvre. In this embodiment, the second guiding means 14 is attached at a central point 40 to the first guiding means 12 and extends on either side therefrom. The second guiding means is rotatably attached to the first guiding means and is positioned above the strings of the instrument when the instrument is in the assembled configuration. Advantageously, the second guiding means is attached to the first guiding means at a central point and comprises free outer ends 42 which advantageously allow the user to feed the strings under the free outer ends 42, assisting the user when changing the strings of the instrument. The instrument that may be used in this embodiment is a steel string acoustic guitar.

The instrument further comprises a slidable extension part 20 adapted to assist in attaching and/or detaching the headstock 6 from the neck 3 of the instrument. The slidable extension part 20 is provided at the distal end of the headstock and is movable from a first position where it is adjacent to the distal end of the headstock to a second position where it extends from the distal end of the headstock. Advantageously, when the slidable extension part 20 is in the second position, the length of the headstock is effectively extended such that the effort required to detach or attach the headstock from or to the neck is reduced. The slidable extension part typically comprises a wooden disc 21 attached to at least one metal rod, preferably two metal rods. Advantageously, the combination of the wooden disc 21 and metal rods 22 provides a lever to assist a user in rapidly removing the strings from the instrument.

The neck 3 is removably connected to the body 2 and the instrument comprises means for detachably securing the neck to the body. The securing means may include means to secure the neck to the body in the assembled position. The instrument further comprises means for adjusting the neck relative to the body of the instrument.

With reference to FIGS. 16 to 20, the junction box 54 acts as an anchor point to connect the neck 3 and body of the instrument. Advantageously, the junction box 54 provides support and ensures mechanical rigidity to the neck 3 and body of the instrument. Advantageously, the reversible attachment of the neck 3 and the body provides flexibility, for example, allowing the neck 3 and body to be reversibly attached to and/or detached from one another during the assembly and/or disassembly of a collapsible instrument. The junction box acts as an anchor point to connect the neck 3 and body of the instrument and allows for quick attachment and/or detachment of the neck to and/or from the body of the instrument.

FIGS. 16a and 17a show a junction box according to an embodiment of the invention, wherein the junction box comprises nylon, such as nylon 12. FIGS. 16b and 17b show a junction box according to another embodiment of the invention, wherein the junction box comprises wood.

The junction box 54 is typically housed within the body of the instrument and may be attached to the body of the instrument by means of glue, a fixation bolt or another attachment mechanism. Surface 60 of the junction box may be attached to the inner surface of the body.

FIG. 17b shows the neck 3 of the instrument in combination with the junction box 54.

The junction box 54 houses a reversible attachment mechanism for joining the neck to the body of the instrument and comprises means for detachably securing the neck 3 to the body of the instrument. The reversible attachment mechanism comprises locking and unlocking means.

FIG. 18a shows a junction box comprising wood. FIG. 18b shows a junction box comprising nylon (such as nylon 12).

As shown in FIG. 18a, the reversible attachment mechanism comprises a latch member 56 provided in the form of a hook mounted on the junction box 54 which may engage with a locking member or locking aperture 59 provided on the neck 3 of the instrument. The junction box shown in FIGS. 18a and 18b comprises a heel 57.

In one embodiment, the latch member 56 may be rotatable. In the embodiment shown in FIG. 18a, the instrument may further comprise an operating handle 58 that may be attached to the heel 57 of the junction box. The operating handle 58 may be attached to the latch member 56. Rotation of the operating handle 58 may drive movement of the latch member 56, to enable a user to move the latch member 56 from a latched position where it engages with a locking member 59 or aperture to a disengaged position. Rotation of the operating handle 58 in the opposite direction may drive movement of the latch member from a disengaged position to a position where it engages with a locking member 59 or aperture.

In another embodiment, the latch member 56 may comprise biasing means, for example, in the form of a locking spring. The provision of a biasing means advantageously assists in the engagement of the latch member 56 with the locking member 59. Preferably, an operating handle 58 may be provided to enable a user to move the latch member 56 from a latched position where it engages with a locking member 59 provided on the neck of the instrument, to a disengaged position against the bias of the locking spring.

The latch member 56 extends to a position just below, in use, the position of the neck 3 of the instrument when the instrument is in the assembled position.

Advantageously, the reversible attachment mechanism does not require the use of any loose fixation parts such as nuts and bolts.

In another embodiment, the neck may be attached to the junction box of the instrument via a fixation bolt.

FIGS. 19a to 19h illustrate various configurations of a junction box 54 in accordance with an embodiment of the present invention. In FIGS. 19a to 19h, the latch member 56 is shown to engage with a locking member 59. The locking member 59 is typically attached to or may form part of the neck 3 of the instrument.

The junction box 54 comprises wood or a plastics material such as nylon and/or polyoxymethylene (known as Delrin). Advantageously, the provision of a junction box 54 comprising a plastics material such as nylon or Delrin increases the strength of the junction box. Advantageously, the provision of a junction box 54 comprising wood provides flexibility for adjustment to the shape of the junction box, if required. In addition, the provision of a junction box comprising wood facilitates attachment of other components to the junction box.

In one embodiment, the junction box 54 is formed by 3D printing. Preferably, the junction box 4 may be formed by 3D printing using a plastics material such as nylon and/or polyoxymethylene (known as Delrin). Advantageously, forming the junction box by 3D printing facilitates manufacture of the junction box. Advantageously, forming the junction box by 3D printing reduces the number of components required to form the junction box. In other embodiments, the junction box may be formed by other moulding methods, for example, injection moulding.

In the assembled position, the neck 3 is attached at its proximal end to the body and at its distal end to a headstock. The headstock is removably connected to the neck so that the disassembled parts can fit entirely within a space defined by the body.

In another embodiment, the neck 3 may be attached to the junction box 54 of the instrument via a fixation bolt.

With reference to FIGS. 16 to 19, there is provided a junction box 54 for use with an instrument, wherein the junction box 54 is adapted to reversibly join the neck 3 and body of the instrument and to provide structural rigidity to the neck and body of the instrument.

With reference to FIGS. 16 to 19, there is provided a method of reversibly attaching a neck and body of an instrument comprising a junction box 54 as defined above.

With reference to FIGS. 16 to 19, there is provided a method of forming a junction box 54 adapted to reversibly join the neck 3 and body of the instrument and to provide structural rigidity to the neck and body of the instrument.

In one embodiment, the method of forming the junction box comprises the step of 3D printing. In another embodiment, the method of forming the junction box may comprise the step of injection moulding.

With reference to FIG. 20, two wheels 62, 64 are provided to permit the neck of the instrument to be adjusted. The wheels 62, 64 are attached to the underside of the neck and are rotatable. Rotation of the wheels adjusts the position of the neck of the instrument relative to the strings. The wheels permit the neck of the instrument to rotate it slightly to the left or right about its longitudinal axis. The wheels 62, 64 comprise a rim 80 which is thicker on one side 82 than the other 84, so that each side of the neck can be raised or lowered with respect to the strings depending on the thickness of the rim of the wheel where it bears against the grooved bearing surface 86 of the junction box (see FIG. 17). Preferably, the wheels 62, 64 are marked on the outer-facing surface 90 such that the user can identify which is the maximum area of thickness and which is the minimum area of thickness. Typically, the maximum area of thickness is around 5 mm. Typically, the minimum area of thickness is around 2 mm. Typically, adjustment of the at least one wheel can only be made when the neck is not locked in place, however, if the wheels are made with sufficiently wide rims they can be accessed by a user when the neck is in situ to aid its adjustment. Advantageously, the presence of at least one wheel allows the user to adjust the height of the strings from the neck differentially on the left and right sides. Typically, the lighter strings on one side have a smaller vibrating amplitude than the heavier strings on the other side. Advantageously, the presence of at least one wheel provides a mechanism to ensure the optimal relative gap between the strings and the neck on the right and left hand side strings respectively.

In one embodiment, the mechanism of attaching the neck to the body may comprise a latch member mounted on the body of the instrument which engages with a locking member mounted on the neck of the instrument. Advantageously, the mechanism of this embodiment does not require the use of any loose fixation parts, such as nuts and bolts, and does not require the use of tools. The latch member may be substantially L-shaped and may comprise a biasing means, for example, in the form of a locking spring. The provision of a biasing means advantageously assists in the engagement of the latch member with the locking member. An operating handle may be provided to enable a user to move the latch member from a latched position where it engages with a locking member provided on the neck of the instrument, to a disengaged position against the bias of the locking spring. In one embodiment, the operating handle may be attached to the latch member. In another embodiment, the neck may be attached to the body of the instrument via a fixation bolt.

The instrument 1 further comprises a bridge 24 for receiving the strings and means for securing the strings to the bridge. Since the tension on the strings is reduced to zero every time the instrument is disassembled, it happens that sometimes the attachment of the strings to the bridge works loose, necessitating their re-attachment. To prevent this from occurring, the strings may be secured to the bridge. Preferably, the instrument comprises means for preventing the strings becoming detached from the bridge when the headstock is removed during disassembly.

With reference to FIGS. 21 and 22, the bridge comprises a detachable portion 7 and a non-detachable portion 25, wherein the non-detachable portion 25 is adapted to secure to the detachable portion 7. Advantageously, the bridge is separated into two portions and the portion that is non-detachable can be used to quickly and efficiently secure the detachable portion. This allows the user to detach and replace the strings to the body of the instrument with minimum effort. The detachable and non-detachable portions form the bridge of the instrument. Advantageously, providing a detachable bridge allows the strings to be rapidly detached from the instrument without them becoming disordered and entangled. On many stringed instruments, the strings are secured to the instrument by passing them through an aperture in the bridge at one end of the instrument. For example, guitars have a bridge that secures the strings to the body of the guitar at one end and to the head of the guitar at the other end. Having a detachable bridge is advantageous as it allows the strings to be detached in order to inspect or replace features of the body or guitar or neck of the guitar, for example, the frets of a guitar can become worn and in need of replacement. Alternatively, a detachable bridge may be useful as part of the disassembly of a collapsible guitar. In one embodiment, the detachable portion of the bridge may be used in conjunction with the detachable headstock, to remove the strings as a single piece. Advantageously, the combination of a detachable bridge and a detachable headstock may form a means for removing the strings from a stringed instrument. Thus, the detachable and non-detachable portions of the bridge of the present invention assist in the rapid release of the strings from the instrument.

The detachable portion 7 further comprises means for reversibly coupling to the strings of the instrument. Typically, the means for reversibly coupling the strings comprises at least one aperture 27 for each of the strings in the detachable portion. This allows the strings to be secured to the detachable portion and to be detached from the body of the instrument as one piece.

The non-detachable portion comprises a string retaining channel 26 for each of the strings which correspond to the position of the strings coupled to the detachable portion such that when the detachable portion is secured by the non-detachable portion, the strings coupled to the detachable portion each sit within a corresponding string retaining channel. The string retaining channels of the non-detachable portion allow the strings coupled to the detachable portion to be held securely in the correct position and allow the strings to be repeatedly struck to create sound without altering the position of the strings along the bridge.

The non-detachable portion 25 comprises a retaining means to prevent inadvertent detachment of the detachable portion, the retaining means adapted to retain the detachable portion against the tension of the strings. This advantageously allows the detachable portion to be held securely to the body of the guitar without the need for any additional components. The retaining means allows the detachable portion to couple to the non-detachable portion and affix the detachable portion firmly without further input or effort from a user. The tension generated by the string forces the detachable portion into contact with the non-detachable portion.

The retaining means comprises means to prevent movement of the detachable portion in a direction substantially perpendicular to the direction of the body. Advantageously, the retaining means prevents the force generated by the taut strings on the instrument from pulling the string away from the body of the stringed instrument. Without the retaining means the strings would be forced away from the body of the stringed instrument and the detachable portion forced perpendicular to the body of the stringed instrument.

The retaining means comprises a lip 28, wherein the lip protrudes in a plane substantially parallel to the body of the instrument in a direction away from the neck of the stringed instrument. The lip protrudes from the non-detachable portion on the end of the detachable portion facing in a direction away from the neck of the stringed instrument. The projection from the non-detachable portion that forms the lip holds the detachable portion in place and provides a stop that secures the detachable portion due to the force of the strings pulling the detachable portion towards the neck and also perpendicular to the body of the instrument.

The lip comprises the string retaining channels 26 through which each string can pass. The string retaining channels 26 allow the strings of the stringed instrument to be guided into position so that they can be secured to the detachable portion and not move when the instrument is played.

The detachable and/or non-detachable portion has a tongue. Preferably, the detachable and/or non-detachable portion comprises a groove, wherein the tongue reversibly couples to the groove such that the tongue is secured by the groove. A tongue and groove arrangement is advantageous as it provides a stable, reversibly releasable system that does not require additional materials to be used in securing the detachable portion to the non-detachable portion.

Advantageously, the strings may be removed from the instrument via the headstock 6 and/or via the bridge 24. Thus, the rapid release means for releasing the strings of the instrument may be provided by the detachable headstock 6, the detachable portion of the bridge 7, and/or the slidable extension part 20.

Preferably, the instrument is a guitar. More preferably, the instrument is a collapsible guitar. Preferably, the instrument may be an acoustic or classical Spanish guitar.

Advantageously, the present invention allows for an instrument to be provided with interchangeable sets of removable rapid-release and rapid refit headstocks 6 fitted with strings and string-guides 12, 14 in which said headstock and said strings may be, for example, of the acoustic or classical guitar type, and in which each set of strings may be pre-attached to a detachable portion 7 of a bridge, the detachable portion of the bridge being designed to reversibly slot into the rear aspect of the non-detachable portion 25 of the bridge, the non-detachable portion of the bridge being fixed by conventional means to the front panel of an instrument body 2 or sound box.

Advantageously, the present invention provides a mechanism for detaching a headstock 6 from, or reattaching a headstock to, a collapsible stringed instrument 1 without unwinding the strings from the headstock 6 or separating them from their attachments at the opposite end (e.g. at the bridge 24), the mechanism simultaneously also either relaxing and/or appropriately tensioning the strings. Typically, relaxing the strings permits the immediate removal of the headstock and strings, e.g. for stowing the headstock and/or neck within the body 2 of the instrument. Typically, tensioning the strings holds and/or locks the headstock and the distal string attachment in place on the instrument.

Advantageously, the invention permits a player to rapidly exchange a complete assembly of a headstock 6, ready mounted strings and the detachable portion of a bridge, which can all be removed as one unit at the same time that the combined tension of the strings has been caused to return to zero by the forward rotation of the headstock on its hinged attachment to the guitar neck. Advantageously, the assembly may be replaced with a second assembly unit designed to fit on the same instrument. This may advantageously assist a player in rapidly exchanging a set of classical strings from a low-tension variety to a harder version variety, allowing different performance characteristics for a different piece of music.

The present invention provides a further advantage as it allows a player to exchange a classical guitar set of guitar strings for an acoustic set of guitar strings, or vice versa, thus changing the nature of the instrument. Preferably, the rapid release mechanism for removing the headstock 6 and the detachable portion 7 of the bridge, together with the strings to which they remain attached, is simply reversed after slotting into place the new headstock and the new detachable portion of the bridge. Preferably, the action of rotating the headstock 6 backwards on its reversible hinged attachment to the outer end of the neck 3 simultaneously tensions the strings and clamps the assembly in place, making for an extremely short overall exchange time.

Advantageously, the neck 3 of the instrument may be separated from the headstock 6 and also from the body 2 of the guitar using a mechanism, in the latter case, which permits fine adjustment of the angle of the neck 3 with respect to the plane of the front of the body 2 of the instrument. Advantageously, such adjustment may be desirable when changing between different string types, for example, acoustic guitar players find it easier to play using a smaller distance between the neck and strings than is usually provided in classical guitars. Preferably, the adjustments to the angle of the neck are made after tensioning the strings, preferably by loosening the neck to body fixation bolt to a greater extent (e.g. in the case of a classical guitar arrangement) or a lesser extent (e.g. in the case of an acoustic guitar arrangement).

Advantageously, the present invention permits a player to avoid the sometimes lengthy process of tuning the strings. For example, if a string breaks during a performance, it is usually necessary for a player to use a spare instrument rather than keeping the audience waiting while a new string is fitted and tuned. Advantageously, the present invention allows an entire set of strings to be exchanged with another set of strings which have previously been tuned, without the requirement for the player to use a spare instrument which he may not be familiar with and which may not have the same characteristics. Advantageously, when replacing the strings in accordance with the present invention, it has been found that only small changes in tuning are required after re-tensioning, in the case of classical guitar strings, while in the case of acoustic guitar strings usually little or no adjustments to the tuning pegs are required, unless the neck-to-guitar body angle has been changed.

In use, the first guiding means 12 may rotate about the second guiding means 14 and the headstock 6 may be released from the neck 3 by disengaging the hinge pin 10 from a corresponding attachment portion 31 on the neck. The user may extend the slidable component 20 away from the distal end of the headstock 6 and use this component as a lever to assist in the quick release of the strings 4 from the instrument. The strings 4 may be detached from the bridge 24 of the instrument by release of the detachable portion 7 of the bridge from the non-detachable portion 25 of the bridge. Therefore, the strings 4 may be removed as a single piece from the instrument, allowing for replacement with an alternative set of strings, if required.

The user may replace the strings of the instrument with another set of strings, for example, by attaching a headstock 6 to the neck 3 of the instrument and/or attaching the detachable portion 7 of the bridge to the non-detachable portion 25 of the bridge. Tension may be applied to the strings and the first guiding means 12 may rotate about the second guiding means 14 such that the first and/or second guiding means hold the strings in position against the neck of the instrument. The retaining pin 18 may be inserted through the second guiding means to further secure the strings in position with respect to the neck of the instrument.

In use, the junction box 54 may be inserted into the body of an instrument such as a collapsible guitar to reversibly join the neck and body of the instrument and to provide support and ensure mechanical rigidity to the neck and body of the instrument. The junction box 54 may be attached to the body of an instrument by means of glue, a fixation bolt, or another attachment mechanism. The junction box is typically attached at surface 60 to the inner surface of the body of an instrument.

The junction box 54 comprises a latch member 56 which engages with a locking member 59 or locking aperture provided on the neck 3 of the instrument. The latch member 56 is attached to an operating handle 58, wherein both the latch member 56 and operating handle 58 are attached to the heel 57 of the junction box 54. Preferably, rotation of the operating handle 58 may drive movement of the latch member 56, to enable a user to move the latch member 56 from a latched position where it engages with a locking member 59 or aperture to a disengaged position. Rotation of the operating handle 58 in the opposite direction may drive movement of the latch member 56 from a disengaged position to a position where it engages with a locking member 59 or aperture.

In another embodiment, the latch member 56 may comprise biasing means, for example, in the form of a locking spring. The provision of a biasing means advantageously assists in the engagement of the latch member 56 with the locking member 59. Preferably, an operating handle 58 may be provided to enable a user to move the latch member 56 from a latched position where it engages with a locking member 59 provided on the neck of the instrument, to a disengaged position against the bias of the locking spring.

Typically, the latch member 56 extends to a position just below, in use, the position of the neck 3 of the instrument when the instrument is in the assembled position. Advantageously, the reversible attachment mechanism does not require the use of any loose fixation parts such as nuts and bolts.

1. A musical instrument comprising a body and a neck for supporting a set of strings, further comprising demountable means for detaching the strings as a single piece from the instrument.

2. A musical instrument comprising a first set of strings and a second set of strings, wherein the instrument is adapted to allow for attachment of either the first set of strings or the second set of strings.

3. A musical instrument comprising a body and a neck for supporting a set of strings, the instrument further comprising a junction box adapted to reversibly join the neck and body of the instrument and to provide structural rigidity to the neck and body of the instrument.

4. An instrument according to claim 1, 2 or 3, wherein the instrument is a collapsible instrument.

5. A musical instrument according to claim 2, 3 or 4, wherein the first set of strings is a set of strings for a classical instrument and the second set of strings is a set of strings for an acoustic instrument.

6. An instrument according to any preceding claim, wherein the instrument comprises a headstock and means for detachably securing the headstock to the neck.

7. An instrument according to any preceding claim, wherein the tension of the strings maintains the instrument in the assembled condition.

8. An instrument according to any preceding claim, comprising means for rapid release of the strings from the instrument.

9. An instrument according to any preceding claim, wherein the instrument comprises first and/or second guiding means for guiding the strings.

10. An instrument according to claim 9, wherein the first guiding means is adapted to pivot, relative to the headstock without lateral movement relative thereto to guide the strings into position relative to each other at the headstock.

11. An instrument according to claim 9 or 10, wherein the second guiding means is adapted to maintain the position of the strings relative to each other at the headstock.

12. An instrument according to any one of claims 9 to 11, wherein the second guiding means comprises a fulcrum.

13. An instrument according to claim 12, wherein the second guiding means is adapted to confer tension to the strings via the fulcrum.

14. An instrument according to claim 12 or 13, wherein the fulcrum is positioned above the strings and prevents the strings from lifting away from the plane of the headstock during rotation of the headstock with respect to the neck of the instrument.

15. An instrument according to claim 12, 13 or 14, wherein the fulcrum comprises a roller bar.

16. An instrument according to any one of claims 9 to 15, wherein the first guiding means is attached to the second guiding means.

17. An instrument according to any one of claims 9 to 16, wherein the second guiding means is adapted to serve as an axis for the first guiding means.

18. An instrument according to any one of claims 9 to 17, wherein the second guiding means is attached to a central rib of the headstock.

19. An instrument according to any one of claims 9 to 18, wherein a central portion of the second guiding means is attached to the first guiding means and/or to the headstock and wherein the second guiding means comprises free outer ends.

20. An instrument according to any preceding claim, further comprising a slidable extension part adapted to assist in attaching and/or detaching the headstock from the neck of the instrument.

21. An instrument according to claim 20, wherein the slidable extension part provides a lever for the rapid release of the headstock from the instrument.

22. An instrument according to any preceding claim, wherein the neck is removably connected to the body.

23. An instrument according to any one of claims 3 to 22, wherein the junction box acts as an anchor point to connect the neck and body of the instrument.

24. An instrument according to any one of claims 3 to 23, wherein the junction box houses a reversible attachment mechanism for attaching and/or detaching the neck to and/or from the body of the instrument.

25. An instrument according to claim 24, wherein the reversible attachment mechanism comprises locking and/or unlocking means.

26. An instrument according to claim 24 or 25, wherein the reversible attachment mechanism comprises a latch member.

27. An instrument according to claim 26, wherein the latch member comprises a hook.

28. An instrument according to claim 26 or 27, wherein the latch member engages with a locking member or locking aperture provided on the neck of the instrument.

29. An instrument according to any one of claims 26 to 28, wherein the latch member is rotatable.

30. An instrument according to any one of claims 26 to 29, wherein the instrument comprises an operating handle attached to the latch member.

31. An instrument according to claim 30, wherein rotation of the operating handle drives movement of the latch member to enable a user to move the latch member from a locked and/or unlocked position to an unlocked and/or locked position.

32. An instrument according to any one of claims 3 to 31, wherein the junction box is housed inside the body of the instrument.

33. An instrument according to claim 32, wherein the junction box is held in place within the body of the instrument by means of a fixation bolt, glue or other attachment means.

34. An instrument according to any one of claims 3 to 33, wherein the junction box comprises wood or a plastics material such as nylon and/or polyoxymethylene (Delrin).

35. An instrument according to any one of claims 3 to 34, wherein the junction box is formed by 3D printing.

36. An instrument according to any one of claims 3 to 34, wherein the junction box is formed by injection moulding.

37. An instrument according to any preceding claim, further comprising means for adjusting the neck of the instrument.

38. An instrument according to any preceding claim, wherein the instrument further comprises at least one wheel.

39. An instrument according to claim 37 or 38, wherein the instrument comprises two wheels.

40. An instrument according to claim 38 or 39, wherein the at least one wheel is rotatable.

41. An instrument according to any one of claims 38 to 40, wherein the at least one wheel permits the neck of the instrument to rotate slightly to the left or right side about its longitudinal axis.

42. An instrument according to claim 41, wherein rotation of the at least one wheel adjusts the position of the neck relative to the strings.

43. An instrument according to any one of claims 38 to 42, wherein the at least one wheel comprises a rim which is thicker on one side than the other, so that each side of the neck can be raised or lowered with respect to the strings depending on the thickness of the rim of the wheel where it bears against a grooved bearing surface of the junction box.

44. An instrument according to any one of claims 38 to 43, wherein the at least one wheel is marked on the outer-facing surface such that the user can identify a maximum area of thickness and a minimum area of thickness.

45. An instrument according to claim 44, wherein the maximum area of thickness is around 5 mm.

46. An instrument according to claim 44 or 45, wherein the minimum area of thickness is around 2 mm.

47. An instrument according to any one of claims 38 to 46, wherein adjustment of the at least one wheel can only be made when the neck is not locked in place.

48. An instrument according to any preceding claim, further comprising a bridge for receiving the strings and means for securing the strings to the bridge.

49. An instrument according to claim 48, wherein the bridge comprises a detachable portion and a non-detachable portion.

50. An instrument according to claim 49, wherein the non-detachable portion is adapted to secure to the detachable portion.

51. An instrument according to claim 49 or 50, wherein the detachable portion further comprises demountable means for coupling to the strings of the instrument.

52. An instrument according to claim 51, wherein the demountable means for coupling the strings comprises at least one aperture for each of the strings in the detachable portion.

53. An instrument according to any one of claims 49 to 52, wherein the non-detachable portion comprises a retaining means to prevent inadvertent detachment of the detachable portion, the retaining means adapted to retain the detachable portion against the tension of the strings.

54. An instrument according to claim 53, wherein the retaining means comprises means to prevent movement of the detachable portion in a direction substantially perpendicular to the direction of the body.

55. An instrument according to claim 53 or 54, wherein the retaining means comprises a lip, wherein the lip protrudes in a plane substantially parallel to the body of the instrument in a direction away from the neck of the stringed instrument.

56. An instrument according to claim 55, wherein the lip comprises the string retaining channels through which each string can pass.

57. An instrument according to any one of claims 49 to 56, wherein the detachable and/or non-detachable portion has a tongue.

58. An instrument according to claim 57, wherein the detachable and/or non-detachable portion comprises a groove, wherein the tongue reversibly couples to the groove such that the tongue is secured by the groove.

59. An instrument according to any one of claims 48 to 58, wherein the strings may be removed from the instrument via the headstock and/or via the bridge.

60. An instrument according to any preceding claim, wherein the instrument is a guitar.

61. An instrument according to claim 60, wherein the instrument is a classical guitar or an acoustic guitar.

62. A method of reversibly attaching a neck and body of an instrument comprising a junction box according to any one of claims 3 to 61.

63. A method of forming an instrument comprising a junction box according to any one of claims 3 to 62.

64. A method according to claim 63, wherein the method of forming the junction box comprises the step of using 3D printing.

65. A method according to claim 63, wherein the method of forming the junction box comprises the step of using injection moulding.
